(19) United States
(12) Patent Application Publication
(10) Pub. No.: US 2005/0165870 A1
(43) Pub. Date: Jul. 28, 2005

(54) Imaging device, viewer software, communication software and image management software

(75) Inventor: Hiroshi Shionoya, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/042,134

(22) Filed: Jan. 26, 2005

(30) Foreign Application Priority Data
Jan. 27, 2004 (JP) 2004-18435

(51) Int. Cl. G06F 17/30

(52) U.S. Cl. 707/204

(57) ABSTRACT

According to the present invention, separately from an image file, an XML file is created in which link information for referencing the image file by link and attached information related to an image of the image file are described, and an archive file is created into which the XML and the image file are archived. Thereby, the attached information related to an image, such as attribute information and image-taking conditions of the image, can be easily utilized. Furthermore, since the two files are archived, handling ability in recording and communication can be advantageously prevented from being impaired.

### BACKGROUND OF THE INVENTION

1. Field of the Invention

The present invention relates to an imaging device, viewer software, communication software and image management software, and in particular to a technique for describing attached information related to an image.

2. Description of the Related Art

As a file format of a digital image, Exif (Exchangeable Image File Format) described in detail in Japanese Patent Application Laid-open No. 2003-110844 is well known. This format has been standardized by Japan Electronics and Information Technology Industries Association (JEIDA) and employed by a lot of digital cameras.

An Exif file is based on a tag format which has been conventionally and widely used. In an Exif file, various attribute information of an image is stored in the tags so that the file can be referenced and utilized.

As an example of a method aiming at giving an effect similar to that the Exif can give, there is a method for configuration by attribute description in a markup language and image files linked thereto. For example, it is common on a website written in HTML (Hypertext Markup Language) that an image can be referenced by clicking an anchor tag. Recently, XML (Extensible Markup Language) has been widely used, in which an attribute (a tag) can be arbitrarily defined.

In Japanese Patent Application Laid-open No. 2001-189905, description is made on a method of recording location information (latitude and longitude) about an image-taking position to a file different from an image file, and an example is described in which Point Of Interest Language (POIX) is used for the different file. POIX is an XML-based markup language for describing data by hierarchically structuring the data with the use of tags.

### SUMMARY OF THE INVENTION

In a file format as represented by Exif, in which attribute information and an image are integrated, the construction and structure (content, length and order) of tags in which attribute information is to be stored are specified. In order to reference or utilize a file, knowledge about the construction and structure is required, and furthermore, a dedicated viewer is also required.

By comparison, in a method employing a markup language, reference and utilization is easy since attribute information is described in plain text. However, the method has a disadvantage that, since an attribute information file and an image file are separate files and the image file is referenced from link information embedded in the attribute information file, the file cannot be referenced in case that a wrong storage position is specified. Especially, when image transmission utilizing communication is assumed, there is difficulty in handling since the two files of attribute information and an image itself must be sent while the link relation therebetween is maintained.

The present invention has been made in consideration of the above situation, and its object is to provide an imaging device capable of creating a file which enables easy utilization of attached information related to an image, such as attribution and image-taking conditions of the image, without impairing handling ability in recording or communication.

Another object of the present invention is to provide viewer software for viewing a file created by the above imaging device, and communication software and image management software for the file.

In order to achieve the above object, a first aspect of the present invention is an imaging device which image-processes an image signal outputted from an imaging section including an imaging element, the imaging device comprising: an XML file generation device which automatically generates an XML file in which link information for referencing the image file by link and attached information related to an image of the image file are described; an archive file creation device which archives the XML file and the image file to create an archive file; and a recording device which records the created archive file to a recording medium.

Since an XML file in which attached information related to an image is described is generated, it is easy to reference and utilize the attached information. Furthermore, since an image file and an XML file are archived into one file (archive file), handling ability in recording and communication can be similar to that of an Exif file.

A second aspect of the present invention is the imaging device according to the first aspect, wherein the archive file creation device compresses and archives the XML file and the image file to create a compressed archive file. Thereby, it is possible not only to reduce recording volume but also to shorten communication time.

A third aspect of the present invention is the imaging device according to the first or second aspect, wherein the archive file creation device self-decompressibly archives the XML file and the image file to create a self-decompressing archive file. Application software is not required for development of an archive file.

A fourth aspect of the present invention is the imaging device according to the first, second or third aspect, further comprising: a password setting device which sets a user password; wherein the XML file generation device describes the user password set by the password setting device in the XML file; and the archive file creation device reads the user password from the XML file and creates an archive file which is decompressed only when the user password is inputted.

Only a user who knows the password can decompress and utilize the file, and thus a privacy/security function is attached.

A fifth aspect of the present invention is viewer software for viewing an archive file created by the imaging device according to any one of the first to fourth aspects; the viewer software causing a computer to realize the functions of: acquiring the archive file from the recording medium directly or via a communication device; decompressing the acquired archive file to obtain an XML file and an image file; and displaying the decompressed XML file on a display device and, by referencing the link information described in the XML file, displaying an image of the decompressed image file on the display device.

The viewer software is viewer software which operates on a personal computer (PC) and the like utilized in combination with the imaging device, and the viewer software acquires an archive file created by the imaging device and decompresses the archive file to acquire an XML file and an image file. Then, the viewer software causes the decompressed XML file to be displayed on a display device, and by referencing link information described in the XML file, causes an image of the image file to be displayed on the display device.

A sixth aspect of the present invention is communication software which sends and receives an archive file created by the imaging device according to any one of the first to fourth aspects; the communication causing a computer to realize the functions of: sending the archive file immediately; and receiving and decompressing the archive file to obtain an XML file and an image file.

Since the two files of the XML file and the image file are communicated as an archive file, the relation therebetween can be maintained, handling ability can be prevented from being impaired. When an archive file is received, the archive file is decompressed to acquire an XML file and an image file.

The seventh aspect of the present invention is image management software which registers and manages an archive file created by the imaging device according to any one of the first to fourth aspects; the image management software causing a computer to realize the functions of: decompressing an archive file to be inputted to acquire an XML file and an image file; extracting text information enclosed by tags from the acquired XML file and registering the image file with a recording device with the text information as retrieval information; and in response to input of the retrieval information, retrieving an image file registered with retrieval information which matches the retrieval information, from the recording device.

It is possible to easily retrieve a desired image by utilizing the text information recorded in the XML file.

According to the present invention, separately from an image file, an XML file is created in which link information for referencing the image file by link and attached information related to an image of the image file are described, and an archive file is created into which the XML and the image file are archived. Thereby, the attached information related to an image, such as attribute information and image-taking conditions of the image, can be easily utilized. Furthermore, since the two files are archived, handling ability in recording and communication can be advantageously prevented from being impaired.

### BRIEF DESCRIPTION OF THE DRAWINGS

FIG. 1 is a block diagram showing an embodiment of an imaging device according to the present invention;

FIG. 2 shows an example of a file structure of an XML file;

FIG. 3 shows that an archive file is created from an image file and an XML file;

FIG. 4 is a flow chart showing the flow of processing from image taking to recording to a recording medium to be performed by a digital camera;

FIG. 5 is a rear view of the digital camera on which an operation screen for setting a password is shown;

FIG. 6 shows an example of a file structure of an XML file in which a password is embedded;

FIG. 7 illustrates the operation of viewer software;

FIGS. 8A and 8B illustrate the operation of communication software;

FIG. 9 illustrates the operation of image management software; and

FIG. 10 is an example of a management table.

### DETAILED DESCRIPTION OF THE PREFERRED EMBODIMENTS

Preferred embodiments of an imaging device, viewer software, communication software and image management software according to the present invention will be now described in detail with reference to accompanying drawings.

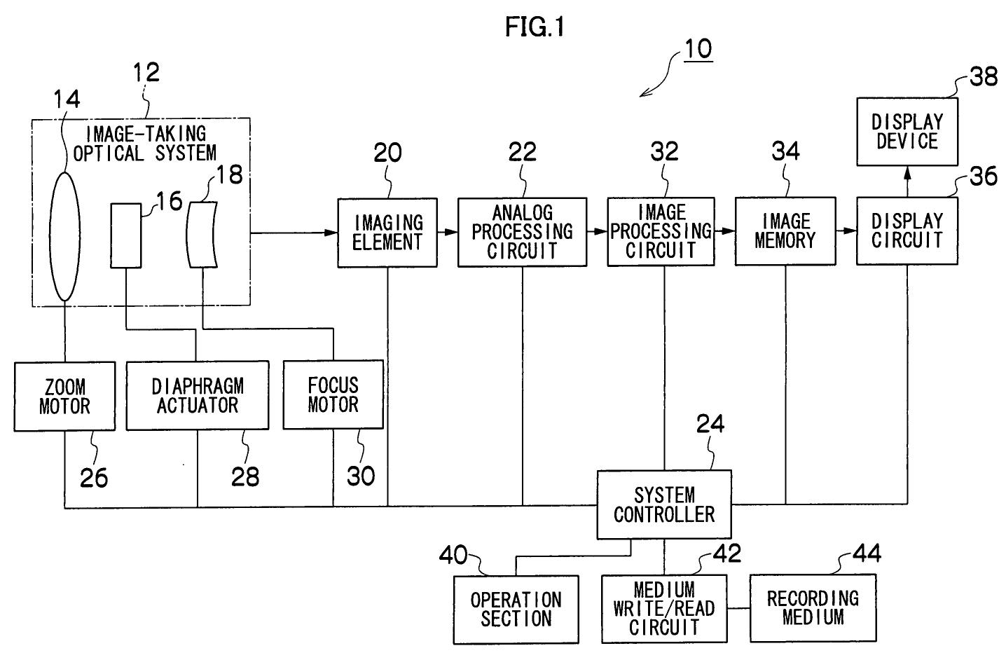

FIG. 1 is a block diagram showing an embodiment of an imaging device according to the present invention.

A digital camera 10 shown in FIG. 1 is an example of an imaging device, and an image-taking optical system 12 of thes digital camera 10 comprises a zoom lens 14, a diaphragm mechanism 16 and a focus lens 18. An object image is formed on the light-receiving surface of an imaging element 20 such as a CCD via the image-taking optical system 12. On the light-receiving surface, the object image is converted into signal charge of an amount corresponding to the quantity of incoming light. The signal charge accumulated on the imaging element 20 is sequentially read as a voltage signal corresponding to signal charge and outputted to an analog processing circuit 22.

The zoom lens 14, the diaphragm mechanism 16 and the focus lens 18 are driven by a zoom motor 26, a diaphragm actuator 28 and a focus motor 30, respectively, which are controlled by a control signal from a system controller 24. The imaging element 20 has a so-called electronic shutter function, a function capable of discharging accumulated signal charge with a shutter gate pulse to control charge accumulation time (shutter speed).

The analog processing circuit 22 has a correlated double sampling circuit (CDS circuit), an amplifier, an A/D converter and the like. The CDS circuit performs correlated double sampling processing on a voltage signal to be inputted. A signal processed by the CDS circuit is gain-controlled by the amplifier and then added to the A/D converter. The A/D converter converts each pixel of the input signal into a digital R, G or B signal and outputs the digital signal to an image processing circuit 32.

For the R, G and B signals added to the image processing circuit 32, signal processings such as white balance adjustment, gamma correction and YC processing are performed at the image processing circuit 32. And a brightness signal Y and chroma signals Cr and Cb (YC signals) for which YC processing has been performed are temporarily stored in an image memory 34. The YC signals stored in the image memory 34 are converted into signals for display via a display circuit 36 and outputted to a display device 38 such as a liquid crystal monitor. Thereby, images such as a through image and a still image which has been taken can be displayed on the display device 38.

The image processing circuit 32 integrates the R, G and B signals added by the analog processing circuit 22 and determines an object brightness (an image-taking EV value) based on the integrated value. Then, the image processing circuit 32 outputs the image-taking EV value to the system controller 24. The image processing circuit 32 also extracts high-frequency components of the R, G and B signals and calculates focus information obtained by integrating the extracted high-frequency components to output the focus information to the system controller 24.

The system controller 24 overall controls the circuits based on input from an operation section 40 (including a shutter button, a mode dial, a cross key and the like); controls driving of the zoom motor 26 to control image-taking magnification; and performs automatic exposure (AE) control for controlling the diaphragm actuator 28 and charge accumulation time of the imaging element 20 based on the image-taking EV value and automatic focus (AF) control for controlling driving of the focus motor 30 based on the focus information.

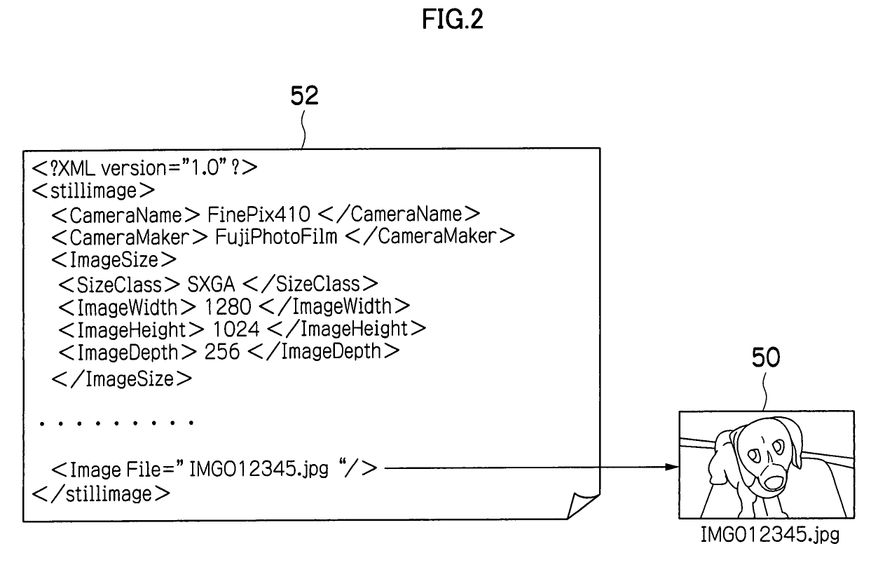

Furthermore, the system controller 24 creates an image file, an XML file and an archive file obtained by integrating the two files. That is, the system controller 24 reads the YC signals temporarily stored in the image memory 34 when an image was taken, and creates a JPEG (joint-photographic experts group)-format image file, which is obtained by JPEG-compressing the YC signals. As shown in FIG. 2, the file name of an image file 50 has been automatically given by the camera by combining alphabets and figures (a sequential number). The image file name of this embodiment is IMG012345.jpg.

The system controller 24 automatically generates an XML file in which attached information related to an image which has been taken, such as attribute information and image-taking conditions of the image, and link information for referencing by link an image file of the image which has been taken.

FIG. 2 shows an example of a file structure of an XML file. As shown in the FIG. 2, in an XML file 52, an XML declaration is described on the first line which indicates that the document is in accordance with XML, and after that, attached information (text) is described with the use of attributes (tags) which can be arbitrarily defined. In the example shown in FIG. 2, a camera model name, a camera manufacturer, an image size and the like are described between a start tag and an end tag. Link information for referencing by link the image file 50 is described with the use of an empty element tag. In the empty element tag, there is an attribute “ImageFile”, and it is indicated that the value is IMG012345.jpg. An empty element tag starts with “<” and closed with a “/>” to be described at the end.

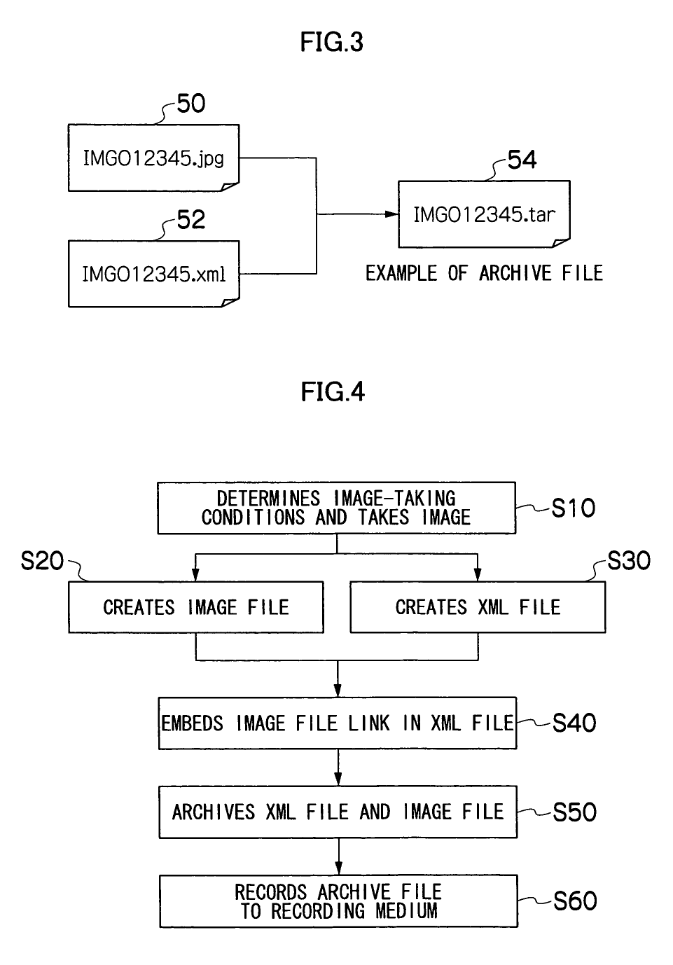

The system controller 24 integrates the created image file 50 and XML file 52 with an archiver into one to create an archive file 54, as shown in FIG. 3. In the embodiment shown in FIG. 3, there is shown a case where a tar (tape archiver) used for the purpose of backup is used as the archiver. The tar does not have a compression function. An archive file integrated by the tar is usually attached with an extension “.tar”.

The image file 50, the XML file 52 and the archive file 54 are given the same file name except the extension of each file name, as shown in FIG. 3.

Returning to FIG. 1, the system controller 24 records the archive file 54 created as described above to a recording medium 44 such as a memory card via a medium write/read circuit 42.

FIG. 4 is a flowchart showing the flow of processing from image taking to recording to a recording medium to be performed by the digital camera 10.

As shown in the FIG. 4, image-taking conditions for an object are determined and an image is taken by the digital camera 10 (step S10). An image signal obtained by this image taking is image-processed to create an image file (step S20). At the same time, an XML file is created in which attached information related to the image such as attribute information and image-taking conditions of the image (for example, time and date of the image taking, shutter speed, diaphragm value, ISO sensitivity, focus distance and the like in addition to camera model name, camera manufacturer and image size described above) is described (step S30).

An image file link for referencing the image file is embedded in the XML file (step S40). Then, the created XML file and the image file are integrated into one by the archiver to create an archive file (step S50). The archive file is recorded to a recording medium of the digital camera 10 (step S60).

Though uncompressed archive file is created by the archiver tar in this embodiment, an archiver “LHA”, which is often used like ZIP, may be used to create a compressed archive file (this file is also called an LZH file because its extension is “lzh”). An archive file may be created with the use of an archiver zip, which is most commonly used in the world and which creates compressed data itself in an executable file format by adding a decompressing program to the top of the compressed data.

To cite an example of link with an image file, if an image file exists in the same folder as the XML file and there is a folder for the each image file, it is possible to archive each folder.

Now, description will be made on a case where a password is embedded in the XML file.

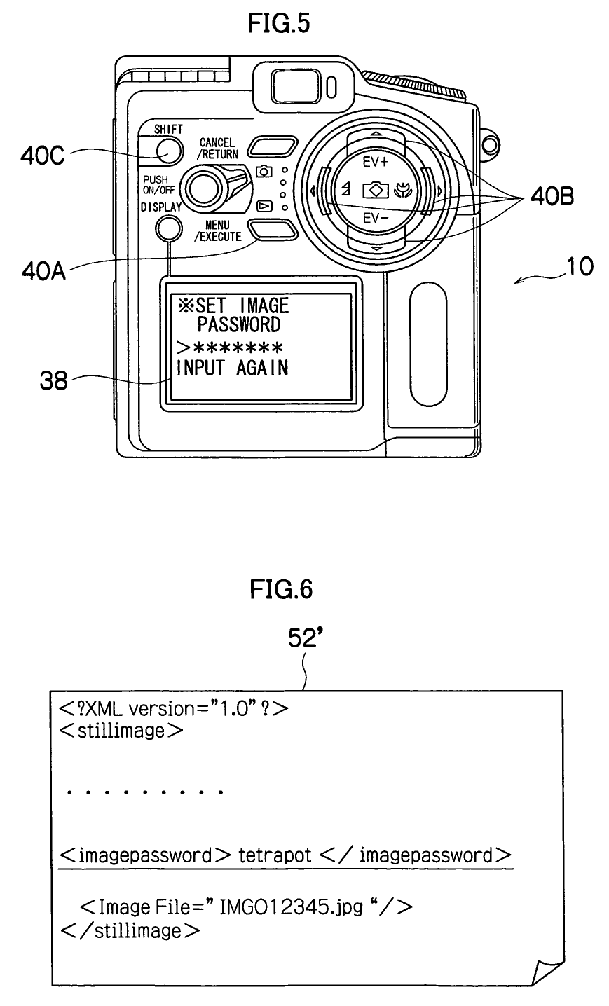

As shown in FIG. 5, by operating a menu/execution button 40A and a cross button 40B for making selection from a menu of the digital camera 10 to select to embed a password in the XML file from the menu, a setting screen for setting a password is displayed on the display device 38 of the digital camera 10. Then, by operating a shift button 40C, a list of alphabets or numeric characters (not shown) is displayed on the screen. By selecting desired alphabets and numeric characters with the cross button 40B and operating the menu/execution button 40A to determine them, a password can be inputted.

If a password has been set for the digital camera 10 as described above, an XML file 52′ is created in which a password (“tetrapot” in this embodiment) is embedded, as shown in FIG. 6.

If a password is described in the XML file, the archiver creates an archive file which can be decompressed only when an inputted password matches the described password. Accordingly, only a user who knows the password can decompress and utilize the archive file.

Now, description will be made on viewer software for viewing an archive file recorded by a digital camera. The viewer software is provided to a user in a CD-ROM packaged together with a digital camera, for example.

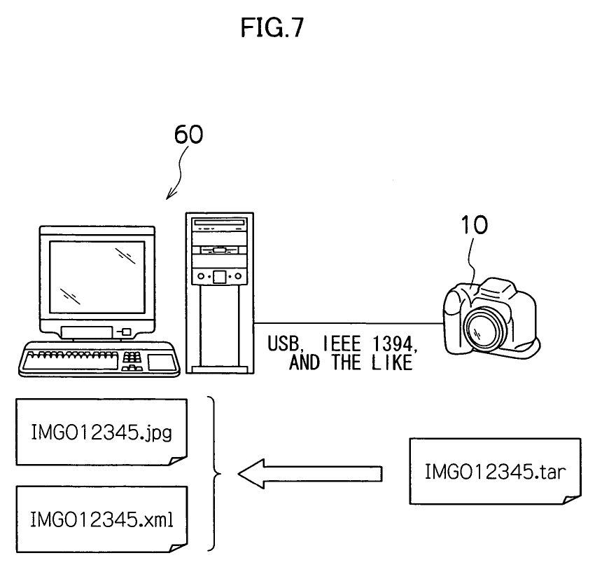

FIG. 7 shows a case where a personal computer (PC) 60 on which the viewer software is installed and the digital camera 10 are connected to each other via a USB interface or an IEEE1394 interface.

When the digital camera 10 is USB-connected when the viewer software has been activated, the viewer software automatically reads an archive file from the digital camera 10, decompresses the archive file to acquire an XML file and an image file, and stores them in a folder specified in advance.

When directed to display the stored XML file, the viewer software displays the XML file on the monitor of the PC 60, and then, by referencing link information about the image file described in the XML file, the viewer software displays an image of the decompressed image file. Information about a display method is not included in the XML file, and only information about data having a tree structure is described therein as shown in FIG. 2. Therefore, the tree structure is displayed.

Now, description will be made on communication software for sending and receiving an archive file recorded by a digital camera.

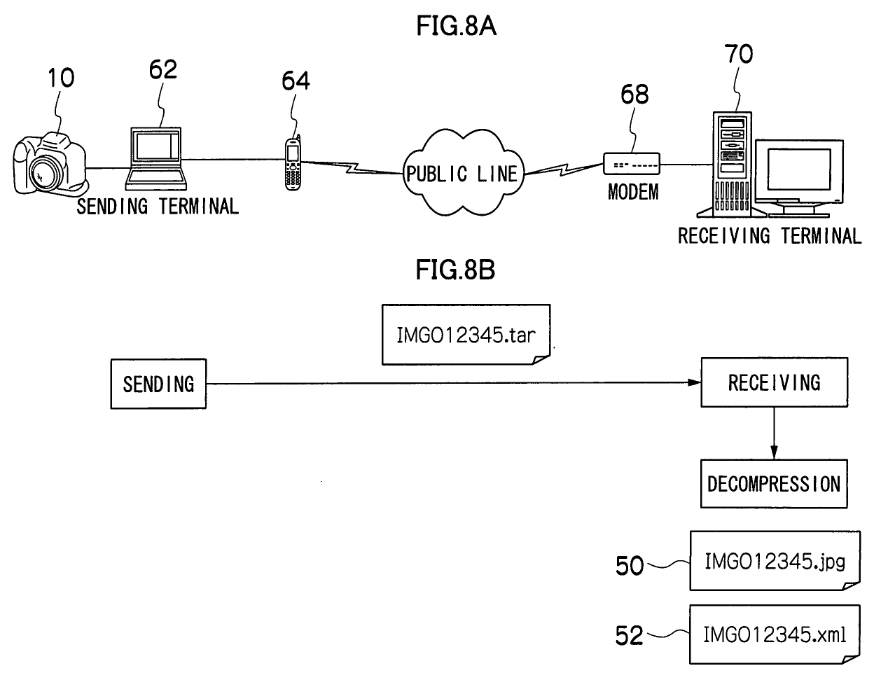

FIG. 8A shows a configuration of a communication system for sending and receiving an archive file, and FIG. 8B shows the flow of communication processing.

On a sending terminal 62 and a receiving terminal 70, communication software for sending and receiving an archive file created by the digital camera 10 is installed. The sending terminal 62 sends an archive file acquired from the digital camera 10 to the receiving terminal 70 via a communication device (a mobile telephone 64 in the example of FIG. 8A) and a public line.

The receiving terminal 70 receives the archive file via a modem 68. When receiving the archive file, the receiving terminal 70 decompresses the archive file to acquire an image file 50 and an XML file 52 and stores these files in a predetermined folder in a hard disk of the receiving terminal 70.

Though the archive file shown in FIG. 8B is an uncompressed file archived by the archiver tar, it is preferable to use a compressed archive file for reduction of communication time.

Now, description will be made on image management software for acquiring an archive file recorded by a digital camera and managing an image file.

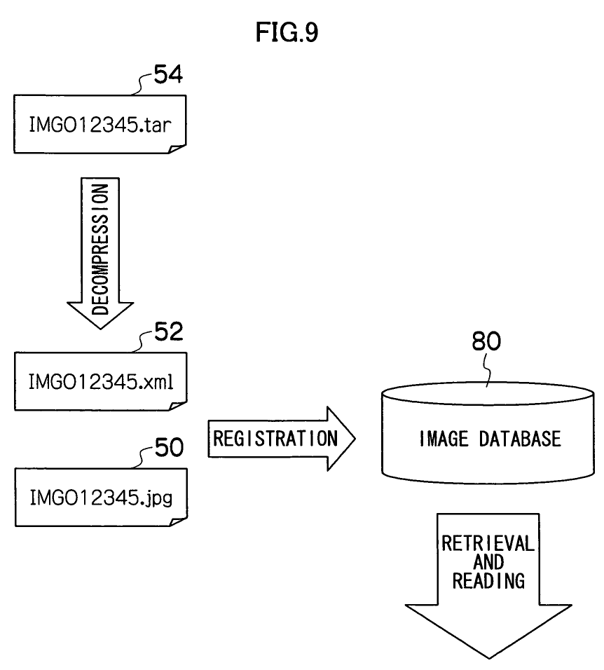

FIG. 9 shows the operation of the image management software for registering and retrieving an image file included in an archive file.

In FIG. 9, when an archive file 54 is acquired into a PC on which the image management software is installed, the image management software decompresses the archive file 54 and acquires an image file 50 and an XML file 52.

Then, the image management software issues image identification information (image ID) unique to the image file, and registers the image file with an image database 80 in association with the image ID.

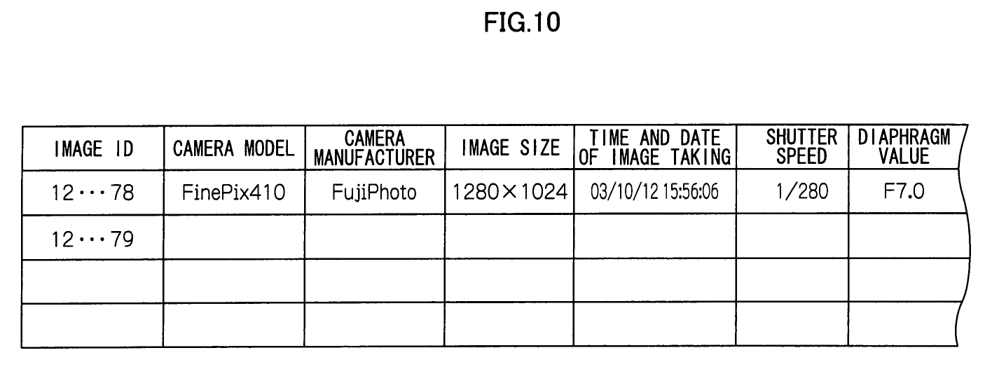

The image database 80 includes a management table used for retrieving and managing a registered image file. The image management software extracts attached information (text information) about the image file 50 enclosed by a start tag and an end tag, from the XML file 52, and registers the extracted text information with the management table in association with the image ID. FIG. 10 shows an example of the management table.

Retrieval of an image from the image database 80 which has been created described above is performed as described below. Text information (keyword) corresponding to a desired image is inputted. Based on this keyword, the management table is referenced and an image ID corresponding to the keyword is retrieved. Then, an image file corresponding to the retrieved image ID is read from the image database 80.

Though an XML file is created by a digital camera in this embodiment, an XML-based XHTML file is also included in the XML file. A style sheet for specifying the form of display may be created and archived by a digital camera together with an XML file.

1. An imaging device which image-processes an image signal outputted from an imaging section including an imaging element to create an image file, comprising:
an XML file generation device which automatically generates an XML file in which link information for referencing the image file by link and attached information related to an image of the image file are described;
an archive file creation device which archives the XML file and the image file to create an archive file; and
a recording device which records the created archive file to a recording medium.

2. The imaging device according to claim 1, wherein the archive file creation device compresses and archives the XML file and the image file to create a compressed archive file.

3. The imaging device according to claim 1, wherein the archive file creation device self-decompressibly archives the XML file and the image file to create a self-decompressing archive file.

4. The imaging device according to claim 2, wherein the archive file creation device self-decompressibly archives the XML file and the image file to create a self-decompressing archive file.

5. The imaging device according to claim 1, further comprising:
a password setting device which sets a user password; wherein
the XML file generation device describes the user password set by the password setting device in the XML file; and
the archive file creation device reads the user password from the XML file and creates an archive file which is decompressed only when the user password is inputted.

6. The imaging device according to claim 2, further comprising:
a password setting device which sets a user password; wherein
the XML file generation device describes the user password set by the password setting device in the XML file; and
the archive file creation device reads the user password from the XML file and creates an archive file which is decompressed only when the user password is inputted.

7. The imaging device according to claim 3, further comprising:
a password setting device which sets a user password; wherein
the XML file generation device describes the user password set by the password setting device in the XML file; and
the archive file creation device reads the user password from the XML file and creates an archive file which is decompressed only when the user password is inputted.

8. The imaging device according to claim 4, further comprising:
a password setting device which sets a user password; wherein
the XML file generation device describes the user password set by the password setting device in the XML file; and
the archive file creation device reads the user password from the XML file and creates an archive file which is decompressed only when the user password is inputted.

9. Viewer software for viewing an archive file created by the imaging device of claim 1; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

10. Viewer software for viewing an archive file created by the imaging device of claim 2; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

11. Viewer software for viewing an archive file created by the imaging device of claim 3; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

12. Viewer software for viewing an archive file created by the imaging device of claim 4; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

13. Viewer software for viewing an archive file created by the imaging device one of claim 5; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

14. Viewer software for viewing an archive file created by the imaging device of claim 6; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

15. Viewer software for viewing an archive file created by the imaging device of claim 7; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

16. Viewer software for viewing an archive file created by the imaging device of claim 8; the viewer software causing a computer to realize the functions of:
acquiring the archive file from the recording medium directly or via a communication device;
decompressing the acquired archive file to obtain an XML file and an image file; and
displaying the decompressed XML file on a display device and, by referencing the link information described in the XML file, displaying an image of the decompressed image file on the display device.

17. Communication software which sends and receives an archive file created by the imaging device of claim 1; the communication software causing a computer to realize the functions of:
sending the archive file immediately; and
receiving and decompressing the archive file to obtain an XML file and an image file.

18. Communication software which sends and receives an archive file created by the imaging device of claim 2; the communication software causing a computer to realize the functions of:
sending the archive file immediately; and
receiving and decompressing the archive file to obtain an XML file and an image file.

19. Communication software which sends and receives an archive file created by the imaging device of claim 3; the communication software causing a computer to realize the functions of:
sending the archive file immediately; and
receiving and decompressing the archive file to obtain an XML file and an image file.

20. Communication software which sends and receives an archive file created by the imaging device of claim 4; the communication software causing a computer to realize the functions of:
sending the archive file immediately; and
receiving and decompressing the archive file to obtain an XML file and an image file.

21. Communication software which sends and receives an archive file created by the imaging device of claim 5; the communication software causing a computer to realize the functions of:
sending the archive file immediately; and
receiving and decompressing the archive file to obtain an XML file and an image file.

22. Communication software which sends and receives an archive file created by the imaging device of claim 6; the communication software causing a computer to realize the functions of:
sending the archive file immediately; and
receiving and decompressing the archive file to obtain an XML file and an image file.

23. Communication software which sends and receives an archive file created by the imaging device of claim 7; the communication software causing a computer to realize the functions of:
sending the archive file immediately; and
receiving and decompressing the archive file to obtain an XML file and an image file.

24. Communication software which sends and receives an archive file created by the imaging device of claim 8; the communication software causing a computer to realize the functions of:
sending the archive file immediately; and
receiving and decompressing the archive file to obtain an XML file and an image file.

25. Image management software which registers and manages an archive file created by the imaging device of claim 1; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

26. Image management software which registers and manages an archive file created by the imaging device of claim 2; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

27. Image management software which registers and manages an archive file created by the imaging device of claim 3; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

28. Image management software which registers and manages an archive file created by the imaging device of claim 4; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

29. Image management software which registers and manages an archive file created by the imaging device of claim 5; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

30. Image management software which registers and manages an archive file created by the imaging device of claim 6; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

31. Image management software which registers and manages an archive file created by the imaging device of claim 7; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.

32. Image management software which registers and manages an archive file created by the imaging device of claim 8; the image management software causing a computer to realize the functions of:
decompressing an archive file to be inputted to acquire an XML file and an image file;
extracting text information enclosed by tags from the acquired XML file and registering the image file with a recording device with the text information as retrieval information; and
in response to input of the retrieval information, retrieving an image file registered with retrieval information which matches the retrieval information, from the recording device.
